(19) United States
(12) Patent Application Publication
(10) Pub. No.: US 2021/0146670 A1
(43) Pub. Date: May 20, 2021

(54) MULTILAYER BODY AND METHOD FOR PRODUCING EPOXY RESIN SHEET

(71) Applicant: Mitsubishi Chemical Corporation, Tokyo (JP)

(72) Inventors: Danna QIAN, Nagahama-shi (JP); Jun MATSUI, Nagahama-shi (JP)

(73) Assignee: Mitsubishi Chemical Corporation, Tokyo (JP)

(21) Appl. No.: 17/161,974

(22) Filed: Jan. 29, 2021

Related U.S. Application Data
(63) Continuation of application No. PCT/JP2019/030314, filed on Aug. 1, 2019.

(30) Foreign Application Priority Data
Aug. 3, 2018 (JP) 2018-146800

(51) Int. Cl. B32B 27/38; C08G 59/50; C08G 59/22; B32B 27/36; B32B 27/32; B32B 27/08

(52) U.S. Cl. CPC B32B 27/38; C08G 59/50; C08G 59/22; B32B 27/36; B32B 2250/24; B32B 27/08; B32B 2250/05; B32B 2307/51; B32B 27/32

(57) ABSTRACT

A laminate having an epoxy resin sheet (A) and a carrier sheet (B) on at least one surface of the epoxy resin sheet (A), wherein the epoxy resin sheet (A) has a tensile storage elastic modulus at 100° C. to 200° C. of 1.0×10⁴ to 6.0×10⁷ Pa and a tensile elongation of 150% or more, the tensile storage elastic modulus at 100° C. to 200° C. of the laminate is 6.0×10⁷ to 1.0×10¹⁰ Pa, and the peel strength between the epoxy resin sheet (A) and the carrier sheet (B) is 5 N/15 mm or less.

### TECHNICAL FIELD

The present invention relates to a laminate and a method for producing an epoxy resin sheet.

### BACKGROUND ART

An epoxy resin is excellent in heat resistance, adhesiveness, waterproofness, mechanical strength, electric properties and others, and is used in various fields. Especially in the electrical and electronics field, with the recent tendency toward down-sizing, refinement and performance improvement of electrical and electronic components, epoxy resins to be used have become required to have advanced moldability. Recently, epoxy resins have become required to be adaptable even to use that seriously requires more flexibility, such as flexible or stretchable laminate plate and others.

PTL 1 discloses a specific highly flexible epoxy resin, saying that a resin composition containing the epoxy resin gives cured products that achieve both adhesiveness and electric properties in a well-balanced manner and have high flexibility.

### CITATION LIST

### Patent Literature

PTL 1: JP 2005-320477 A

### SUMMARY OF INVENTION

### Technical Problem

When a highly flexible epoxy resin cured product is thinned and formed into a single-layer sheet, the resultant single-layer sheet has an advantage of being excellent in stretchability. However, high stretchability also means low dimensional stability, and therefore the single-layer sheet has another side of poor handleability. In particular, when a stretchable single-layer sheet is used in a continuous secondary working step, such as roll-to-roll, there may occur some defects of elongation, deflection and wrinkling.

The present invention has been made in consideration of such situations, and an object of the present invention is to provide an epoxy resin sheet-containing laminate that secures good handleability in secondary working (namely, suppressed in defects of elongation, deflection and wrinkling), and to provide a method for producing an epoxy resin sheet.

### Solution to Problem

As a result of assiduous studies, the present inventors have found that a laminate having a specific configuration can readily solve the above-mentioned problems and have completed the present invention.

Specifically, the present invention relates to the following [1] to [13].
[1] A laminate including an epoxy resin sheet (A) and a carrier sheet (B) on at least one surface of the epoxy resin sheet (A), wherein:

the epoxy resin sheet (A) has a tensile storage elastic modulus at 100° C. to 200° C. of 1.0×10⁴ to 6.0×10⁷ Pa and a tensile elongation of 150% or more, the tensile storage elastic modulus at 100° C. to 200° C. of the laminate is 6.0×10⁷ to 1.0×10¹⁰ Pa, and

the peel strength between the epoxy resin sheet (A) and the carrier sheet (B) is 5 N/15 mm or less.
[2] The laminate according to the above [1], having the carrier sheet (B) on both surfaces of the epoxy resin sheet (A).
[3] The laminate according to the above [1] or [2], wherein the carrier sheet (B) includes a polyester film.
[4] The laminate according to any of the above [1] to [3], wherein the carrier sheet (B) includes a release layer.
[5] The laminate according to any of the above [1] to [4], wherein the carrier sheet (B) has a two-layered configuration of a polyester film and a polyolefin film.
[6] The laminate according to the above [5], wherein, in the carrier sheet (B), the layer thickness ratio of the polyester film to the polyolefin film is polyester film/polyolefin film=0.2 to 10.
[7] The laminate according to any of the above [1] to [6], wherein the epoxy resin sheet (A) is formed of a cured product obtained by curing an epoxy resin composition containing an epoxy resin and an alicyclic polyamine.
[8] The laminate according to the above [7], wherein the epoxy resin has a block structure of a rigid component and a soft component.
[9] The laminate according to any of the above [1] to [8], having a thickness of 30 μm to 1000 μm.
[10] A laminate obtained by peeling the carrier sheet (B) from one surface of the laminate of any of the above [1] to [9].
[11] A flexible or stretchable laminate plate using the epoxy resin sheet (A) of the laminate of any of the above [1] to [10].
[12] A method for producing an epoxy resin sheet, including a step of peeling the carrier sheet (B) from the laminate of any of the above [1] to [10] to give the epoxy resin sheet (A).
[13] A wound body obtained by winding a laminate that has an epoxy resin sheet (A) and a carrier sheet (B) on at least one surface of the epoxy resin sheet (A), around a core, wherein:

the epoxy resin sheet (A) has a tensile storage elastic modulus at 100° C. to 200° C. of 1.0×10⁴ to 6.0×10⁷ Pa, and a tensile elongation of 150% or more,

the tensile storage elastic modulus at 100° C. to 200° C. of the laminate is 6.0×10⁷ to 1.0×10¹⁰ Pa, and

the peel strength between the epoxy resin sheet (A) and the carrier sheet (B) is 5 N/15 mm or less.

### Advantageous Effects of Invention

Using the laminate of the present invention makes it possible to prevent defects of elongation, deflection and wrinkling of an epoxy resin sheet during secondary working. By peeling the carrier sheet after working, an epoxy resin sheet excellent in stretchability can be obtained easily without causing disfigurement.

### DESCRIPTION OF EMBODIMENTS

Hereinunder the present invention is described based on embodiments thereof. However, the present invention is not restricted to the embodiments described below.

### [Laminate]

The laminate of the present invention has an epoxy resin sheet (A) and a carrier sheet (B) on at least one surface of the epoxy resin sheet (A), wherein the epoxy resin sheet (A) has a tensile storage elastic modulus at 100° C. to 200° C. of 1.0×10⁴ to 6.0×10⁷ Pa and a tensile elongation of 150% or more, the tensile storage elastic modulus at 100° C. to 200° C. of the laminate is 6.0×10⁷ to 1.0×10¹⁰ Pa, and the peel strength between the epoxy resin sheet (A) and the carrier sheet (B) is 5 N/15 mm or less.

The tensile storage elastic modulus at 100° C. to 200° C. of a general epoxy resin sheet is 0.1 GPa to 10 GPa or so, and the tensile elongation thereof is 10% or so. Accordingly, the epoxy resin sheet (A) at which the present invention targets is far softer than a general epoxy resin sheet and therefore can be positioned as a special epoxy resin sheet.

The present invention has solved the problems especially intrinsic to such a highly flexible epoxy resin sheet (A), that is, the problems in handleability during secondary working (defects of elongation, deflection and wrinkling). Naturally, secondary working is easy for general epoxy resin sheets that are originally rigid, and therefore the problems now discussed in the present invention do not occur in such sheets.

In the present invention, a carrier sheet (B) to be mentioned below is provided on at least one surface of an epoxy resin sheet (A) to be mentioned below so that the tensile storage elastic modulus at 100° C. to 200° C. of the resultant laminate could be controlled to be 6.0×10⁷ to 1.0×10¹⁰ Pa. Having such a tensile storage elastic modulus, the laminate could suppress the defects of elongation, deflection and wrinkling of an epoxy resin sheet during secondary working and could improve the handleability of the resin sheet.

Describing in more detail, when the tensile storage elastic modulus at 100° C. to 200° C. of the laminate is not lower than the above-mentioned lower limit, not only deflection and wrinkling can be suppressed but also, for example, when the laminate is die-cut, the laminate does not stick to the die-cutting blade and the dimensional stability of the die-cut part can be good, even though the epoxy resin sheet (A) is flexible.

In addition, when the tensile storage elastic modulus at 100° C. to 200° C. of the laminate is not higher than the above-mentioned upper limit, the laminate can be readily formed into a wound body (roll) and, when the wound body is stored as such for a long period of time and then unrolled in secondary working, the wound body can maintain the original shape thereof, such as few thickness fluctuation, and can maintain various properties.

Further, when the peel strength between the epoxy resin sheet (A) and the carrier sheet (B) is 5 N/15 mm or less, the carrier sheet can be peeled from the epoxy resin sheet without detracting from the peeled face of the epoxy resin sheet and therefore an epoxy resin sheet or a laminate excellent in flexibility can be obtained easily.

“The tensile storage elastic modulus at 100° C. to 200° C. is 6.0×10⁷ to 1.0×10¹⁰ Pa” means that the tensile storage elastic modulus keeps a value of 6.0×10⁷ Pa or more and 1.0×10¹⁰ Pa or less in an overall temperature range of 100° C. to 200° C. The same shall apply to the other numerical range. Specifically, the tensile storage elastic modulus of the laminate can be measured according to the method described in the section of Examples.

The tensile storage elastic modulus at 100° C. to 200° C. of the laminate of the present invention is preferably 6.0×10⁷ to 5.0×10⁹ Pa, more preferably 1.0×10⁸ to 1.0×10⁹ Pa.

The laminate of the present invention has a carrier sheet (B) laminated on at least one surface of an epoxy resin sheet (A) and has a tensile storage elastic modulus at 100° C. to 200° C. falling within a specific range, and therefore has good deflection resistance (that is, has little deflection variate). The deflection variate of the laminate of the present invention is preferably 7.0 mm or less, more preferably 6.0 mm or less, even more preferably 5.0 mm or less. Specifically, the deflection variate of the laminate can be measured according to the method described in the section of Examples.

The laminate of the present invention has a carrier sheet (B) laminated on at least one surface of an epoxy resin sheet (A) and has a tensile storage elastic modulus at 100° C. to 200° C. falling within a specific range, and therefore has good elongation resistance. The elongation of the laminate of the present invention is preferably 20% or less, more preferably 10% or less, even more preferably 2.0% or less. Specifically, the elongation of the laminate can be measured according to the method described in the section of Examples.

The laminate of the present invention can have a carrier sheet (B) on both surfaces of an epoxy resin sheet (A), and in the case, a first carrier sheet (B) and a second carrier sheet (B) can be the same as or different from each other.

The laminate of the present invention can have any other layer than an epoxy resin sheet (A) and a carrier sheet (B) within a range that satisfies the above-mentioned tensile storage elastic modulus, and examples of the layer include a sticky layer, an adhesive layer, a hard coat layer and a barrier layer.

The thickness of the laminate of the present invention is preferably 30 μm to 1000 μm, more preferably 50 μm to 500 μm, even more preferably 80 μm to 400 μm, especially more preferably 100 μm to 350 μm. Specifically, the thickness of the laminate can be measured according to the method described in the section of Examples.

A method for producing the laminate of the present invention is not specifically limited but preferably includes applying a resin composition for an epoxy resin sheet (A) (hereinafter this may be referred to as “epoxy resin composition”) on a carrier sheet (B) and curing the epoxy resin composition to form the epoxy resin sheet (A).

In the present invention, the term “epoxy resin” includes both a raw material resin before curing and a resin after curing (cured product). The epoxy group is consumed by curing, and therefore, the cured resin may not have an epoxy group (epoxy structure).

In the case of producing a laminate having a carrier sheet (B) on both surfaces of an epoxy resin sheet (A), the following production method 1 and production method 2 are employable.

Production method 1: A method of applying an epoxy resin composition on a first carrier sheet (B) and curing the epoxy resin composition to form an epoxy resin sheet (A), and then sticking a second carrier sheet (B) to the other surface of the epoxy resin sheet (A) opposite to the surface thereof on which the first carrier sheet (B) has been formed.

Production method 2: A method of applying an epoxy resin composition on a first carrier sheet (B), then sticking a second carrier sheet (B) to the other surface of the first carrier sheet (B) coated with the epoxy resin composition, and then curing the epoxy resin composition to form an epoxy resin sheet (A).

Details of the epoxy resin sheet (A) and the carrier sheet (B) that the laminate of the present invention has are described below.

### <Epoxy Resin Sheet (A)>

In the present invention, the epoxy resin sheet (A) is a sheet having a tensile storage elastic modulus at 100° C. to 200° C. of 1.0×10⁴ to 6.0×10⁷ Pa and a tensile elongation of 150% or more, and excellent in stretchability.

“The tensile storage elastic modulus at 100° C. to 200° C. is 1.0×10⁴ to 6.0×10⁷ Pa” means that the tensile storage elastic modulus keeps a value of 1.0×10⁴ Pa or more and 6.0×10⁷ Pa or less in an overall temperature range of 100° C. to 200° C. The same shall apply to the other numerical range. Specifically, the tensile storage elastic modulus and the tensile elongation of the epoxy resin sheet (A) can be measured according to the method described in the section of Examples.

In the present invention, the tensile storage elastic modulus at 100° C. to 200° C. of the epoxy resin sheet (A) is preferably 6.0×10⁴ to 1.0×10⁷ Pa, more preferably 4.0×10⁵ to 9.0×10⁶ Pa.

In the present invention, the tensile elongation of the epoxy resin sheet (A) is 150% or more, preferably 200% or more, more preferably 300% or more. The upper limit is preferably 500% or less.

In the present invention, the thickness of the epoxy resin sheet (A) is generally 10 μm to 500 μm, preferably 20 μm to 200 μm, more preferably 30 μm to 150 μm, even more preferably 50 μm to 140 μm. The thickness (average thickness) of the epoxy resin sheet (A) is measured with a micrometer and then is an arithmetic average of the found data.

The thickness fluctuation of the epoxy resin sheet (A) is preferably smaller, as meaning uniform thickness. The thickness fluctuation of the epoxy resin sheet (A) is preferably ±20% or less, more preferably ±10% or less.

Specifically, the thickness fluctuation of the epoxy resin sheet (A) can be measured according to the method described in the section of Examples.

In the present invention, the epoxy resin sheet (A) is a sheet-like molded article that is configured of a cured product obtained by curing an epoxy resin composition. “Curing” as referred to herein means intentionally curing the epoxy resin in an epoxy resin composition by heat and/or light, etc. “Intentionally” as referred to herein includes a case of gradually curing an uncured epoxy resin sheet (A) owing to temporal influence of heat or light thereon, for example, during storage for a long period of time.

The epoxy resin sheet (A) can be produced by curing an epoxy resin composition in a sheet-like state controlled so as to have a predetermined thickness. Alternatively, the sheet can also be produced by sheet-like molding a semi-cured product of an epoxy resin composition to have a predetermined thickness and further curing the semi-cured product.

The method for curing an epoxy resin composition may vary depending on the compounding components in the epoxy resin composition, the compounding ratio thereof, and the shape of the compounded product (for example, the thickness of sheet), in general, a heating condition at 23 to 200° C. for 5 minutes to 24 hours can be employed. The heating is preferably a two-stage treatment of primary heating at 23 to 160° C. for 5 minutes to 24 hours and secondary heating at 80 to 200° C. higher than the primary heating temperature by 40 to 177° C., or a three-stage treatment additionally including tertiary heating at 100 to 200° C. higher than the secondary heating temperature for 5 minutes to 24 hours, from the viewpoint of reducing curing failures.

In producing a cured product via a semi-cured product, an epoxy resin composition may be semi-cured by heating, etc. in such a degree that the resultant semi-cured product could maintain the shape thereof. In the case where the epoxy resin composition contains a solvent, most solvent is removed by a method of heating, depressurizing, air-drying, etc., but the solvent may remain in a semi-cured product in an amount of 5% by mass or less.

The laminate of the present invention includes a case where the epoxy resin sheet (A) is in a semi-cured state, so far as the tensile storage elastic modulus at 100° C. to 200° C. and the tensile elongation thereof each fall within the above-mentioned range. As the case may be, the laminate where the epoxy resin sheet (A) is in a semi-cured state can be readily formed into a wound body or can be worked well in secondary working.

An epoxy resin composition favorably used in the present invention (hereinafter also referred to as “epoxy resin composition (a)”) is described in detail hereinunder. However, the epoxy resin composition for use in the present invention is not limited to the epoxy resin composition (a).

### (1. Epoxy Resin Composition (a))

The epoxy resin composition (a) preferably contains an epoxy resin having block structures of a rigid component and a soft component (hereinunder referred to as “epoxy resin (α)”). Here, the rigid component preferably contains an aromatic cyclic structure, for example, a benzene ring, a condensed aromatic structure such as a naphthalene ring, an anthracene ring or a pyrene ring, a structure containing a number of aromatic ring structures such as a biphenol ring, a cardo structure or a fluorene ring, or a heterocyclic structure such as a pyrrole ring or a thiophene ring. The soft component preferably contains an aliphatic hydrocarbon, for example, an alkylene group having 1 to 8 carbon atoms, an ethylene glycol group, a propylene glycol group, or a butylene glycol group. Containing such an epoxy resin (α), the cured product can be flexible. The epoxy resin composition (a) is not always necessary to have an epoxy group or an epoxy group-derived structure in both the rigid component and the soft component. Namely, at least any of the rigid component and the soft component may have an epoxy group or an epoxy group-derived structure. From the viewpoint of imparting flexibility while securing the characteristics such as heat resistance and mechanical strength intrinsic to epoxy resin, preferably, at least any one alone of the rigid component and the soft component has an epoxy resin or an epoxy group-derived structure.

The epoxy resin composition (a) contains at least the epoxy resin (α) and a curing agent, and as needed, any other epoxy compound than the epoxy resin (α), as well as a curing accelerator and any other component may be optionally blended therein.

The epoxy resin composition (a) may contain one kind alone of an epoxy resin (α), or may contain two or more kinds thereof. For the curing agent to be contained in the epoxy resin composition (a), all generally known as an epoxy resin curing agent are usable. The epoxy resin composition (a) may contain one kind alone of a curing agent, or may contain two or more kinds thereof.

### (1-1. Epoxy Resin (α))

Not specifically limited, examples of the epoxy resin (α) include a copolymer of bisphenol F and 1,6-hexanediol diglycidyl ether, a copolymer of 1,6-hexanediol and bisphenol F diglycidyl ether, a copolymer of bisphenol F and 1,4-butanediol diglycidyl ether, a copolymer of 1,4-butanediol and bisphenol F diglycidyl ether, a copolymer of bisphenol A and 1,6-hexanediol diglycidyl ether, a copolymer of 1,6-hexanediol ad bisphenol A diglycidyl ether, a copolymer of bisphenol A and 1,4-butanediol diglycidyl ether, a copolymer of 1,4-butanediol and bisphenol A diglycidyl ether, a copolymer of tetramethylbiphenol and 1,6-hexanediol diglycidyl ether, a copolymer of 1,6-hexanediol and tetramethylbiphenol diglycidyl ether, a copolymer of tetramethylbiphenol and 1,4-butanediol diglycidyl ether, a copolymer of 1,4-butanediol and tetramethylbiphenol diglycidyl ether, a copolymer of biphenol and 1,6-hexanediol diglycidyl ether, a copolymer of 1,6-hexanediol and biphenol diglycidyl ether, a copolymer of biphenol and 1,4-butanediol diglycidyl ether, a copolymer of 1,4-butanediol and biphenol diglycidyl ether, a copolymer of 1,4-naphthalenediol and 1,6-hexanediol diglycidyl ether, a copolymer of 1,6-hexanediol and 1,4-naphthalenediol diglycidyl ether, a copolymer of 1,4-naphthalenediol and 1,4-butanediol diglycidyl ether, a copolymer of 1,4-butanediol and 1,4-naphthalenediol diglycidyl ether, a copolymer of 1,6-naphthalenediol and 1,6-hexanediol diglycidyl ether, a copolymer of 1,6-hexanediol and 1,6-naphthalenediol diglycidyl ether, a copolymer of 1,6-naphthalenediol and 1,4-butanediol diglycidyl ether, and a copolymer of 1,4-butanediol and 1,6-naphthalenediol diglycidyl ether.

One kind alone of these may be used, or two or more kinds thereof may be used, as combined in any manner and in any ratio. Among these, from the viewpoint of flexibility, the epoxy resin (α) is preferably a copolymer of bisphenol F and 1,6-hexanediol diglycidyl ether.

### (1-2. Curing Agent)

The curing agent for use in the present invention is a substance that contributes toward crosslinking reaction between the crosslinking groups in the epoxy resin (α). The curing agent is not specifically limited, and all generally known as an epoxy resin curing agent are usable. Examples thereof include a phenol-based curing agent, an amine-based curing agent such as an aliphatic amine, a polyether amine, an alicyclic amine, and an aromatic amine, an acid anhydride-based curing agent, an amide-based curing agent, a tertiary amine, an imidazole and a derivative thereof, organic phosphine compounds, a phosphonium salt, a tetraphenylboron salt, an organic acid dihydrazide, a boron halide-amine complex, a polymercaptan-based curing agent, an isocyanate-based curing agent, and a blocked isocyanate-based curing agent. From the viewpoint of high transparency and little coloration, the curing agent is preferably one having an alicyclic structure.

Not specifically limited, the alicyclic structure-having curing agent may be any substance that contributes toward crosslinking reaction and/or chain extension reaction between the epoxy groups in an epoxy resin, and examples thereof include an alicyclic polyamine, and an alicyclic acid anhydride. More specifically, they include 1,4-diazabicyclo-2,2,2-octane, 1,8-diazabicyclo-5,4,0-undec-7-ene, N,N′-dimethylpiperazine, N-aminoethylpiperazine, menthenediamine, isophoronediamine, hexamethylenetetramine, methylenebiscyclohexanamine, 1,3-bisaminomethylcyclohexane, norbornanediamine, 1,2-diaminocyclohexane, and modified alicyclic polyamines produced by epoxy-modification or ethylene oxide-modification, or dimer acid-modification, Mannich-modification, Michael-addition, thiourea-condensation or ketimination of the above-mentioned alicyclic polyamines, and hexahydrophthalic acid anhydride and methylhexahydrophthalic acid anhydride.

Among these, alicyclic polyamines are preferred, and among these, isophoronediamine, hexamethylenetetramine, methylenebiscyclohexanamine, 1,3-bis aminomethylcyclohexane, norbornanediamine, 1,2-diaminocyclohexane and derivatives thereof are especially preferred.

As the alicyclic structure-having curing agent, commercial products can be used, and examples thereof include “jER Cure 113” and “jER Cure ST-14” by Mitsubishi Chemical Corporation, and “Rikacid MH-700” by New Japan Chemical Co., Ltd.

The content of the curing agent in the epoxy resin composition (a) (in the case where any other curing agent than the alicyclic structure-having curing agent is used, the total content of the alicyclic structure-having curing agent and the other curing agent) is preferably 0.1 to 100 parts by mass relative to 100 parts by mass of the epoxy resin (α) (in the case where any other epoxy compound to be mentioned below than the epoxy resin (α) is contained, the total content of the epoxy resin (α) and the other epoxy resin), more preferably 80 parts by mass or less, even more preferably 60 parts by mass or less, and especially preferably 40 parts by mass or less.

### (1-3. Other Epoxy Compound)

In the case where the epoxy resin composition (a) contains any other epoxy compound than the epoxy resin (α), examples of the other epoxy compound include one or more kinds of various epoxy resins, such as glycidyl ether-type epoxy resins such as bisphenol A-type epoxy resins, bisphenol F-type epoxy resins, bisphenol S-type epoxy resins, biphenyl-type epoxy resins, phenol-novolak-type epoxy resins and cresol-novolak-type epoxy resins, and glycidyl ester-type epoxy resins, glycidylamine-type epoxy resins, linear aliphatic epoxy resins, alicyclic epoxy resins, and heterocyclic epoxy resins.

In the case where the epoxy resin composition (a) contains an epoxy resin (α) and any other epoxy compound, the proportion of the other epoxy compound in all the epoxy components as a solid content in the epoxy resin composition is preferably 5% by mass or more, more preferably 10% by mass or more, and is, on the other hand, preferably 95% by mass or less, more preferably 90% by mass or less. The proportion of the other epoxy compound not lower than the lower limit secures the effect of improving the physical properties of the composition by blending the other epoxy compound therein. On the other hand, the proportion of the other epoxy compound not higher than the upper limit secures the effect of improving the softness and flexibility owing to the epoxy resin (α).

In the present invention, “solid content” means a component from which a solvating medium has been removed and includes not only a solid epoxy resin or epoxy compound but also in a state of a semi-solid or viscous liquid. “All epoxy components” means a total of the epoxy resin (α) and the other epoxy compound.

### (1-4. Solvent)

The epoxy resin composition (a) may be diluted with a solvent as blended for moderately controlling the viscosity of the epoxy resin composition in handling it for coating film formation. In the epoxy resin composition (a), the solvent is for securing handleability and workability of the epoxy resin composition in molding, and the amount thereof to be used is not specifically limited. In the present invention, a term “solvent” and a term “solvating medium” are differentiated depending on the type of usage thereof, and for these, independently the same ones or different ones can be used.

Examples of the solvent that the epoxy resin composition (a) can contain include acetone, methyl ethyl ketone, toluene, xylene, methyl isobutyl ketone, ethyl acetate, ethylene glycol monomethyl ether, N,N-dimethylformamide, N,N-dimethylacetamide, methanol, and ethanol. Two or more kinds of these solvents can be used appropriately as a mixed solvent thereof.

### (1-5. Other Components)

The epoxy resin composition (a) can contain any other component in addition to the above-mentioned components. The other components can be used appropriately as combined depending on the desired properties of the epoxy resin composition.

For example, for the purpose of improving various properties, for example, as an effect of lowering curing shrinkage of the resultant cured products or an effect of lowering thermal expansion thereof, an inorganic filler can be blended in the epoxy resin composition (a) to thereby seek application development of the composition in electric and electronic field, especially for liquid semiconductor sealants. An inorganic filler such as rubber particles or acrylic particles can be blended for imparting toughness.

The usable inorganic filler includes a powdery reinforcing agent or filler, and examples thereof include metal oxides such as aluminum oxide and magnesium oxide, metal carbonates such as calcium carbonate and magnesium carbonate, silicon compounds such as diatomaceous earth powder, basic magnesium silicate, calcined clay, fine powdery silica, fused silica and zeolite, metal hydroxides such as aluminum hydroxide, and others such as kaolin, mica, quartz powder, graphite, carbon black, carbon nanotube, molybdenum disulfide, boron nitride, and aluminum nitride.

In the case where an inorganic filler is added, the tensile storage elastic modulus of the epoxy resin sheet layer and the laminate thereof need to be secured within the above-mentioned range. The amount of the inorganic filler to be added is preferably 900 parts by mass or less relative to 100 parts by mass of the sum of the epoxy resin (total of the epoxy resin (α) and the other epoxy resin optionally used—the same shall apply hereinunder) and the curing agent. On the other hand, the lower limit is not specifically limited but is preferably 1.0 part by mass or more.

Further, a fibrous reinforcing agent or filler can be blended. Examples thereof include glass fibers, ceramic fibers, carbon fibers, alumina fibers, silicon carbide fibers, boron fibers, aramid fibers, cellulose nanofibers, and cellulose nanocrystals. A cloth or a nonwoven fabric of organic fibers or inorganic fibers can also be used. Further, these inorganic fillers, fibers, cloth and nonwoven fabric that is surface-treated with a silane coupling agent, a titanate coupling agent or an aluminate coupling agent or by applying primer treatment are usable.

Further, if desired, a coupling agent, a plasticizer, a diluent, a flexibility imparting agent, a dispersant, a wetting agent, a colorant, a pigment, a UV absorbent, a light stabilizer such as a hindered amine-type light stabilizer, an antioxidant, a defoaming agent, a release agent and a fluidity improver can be blended in the epoxy resin composition (a). The amount thereof to be added is preferably 20 parts by mass or less relative to 100 parts by mass of the sum of the epoxy resin and the curing agent. On the other hand, the lower limit is not specifically limited but is preferably 0.1 part by mass or more.

Further, for the purpose of improving the properties of the resin in the final coating film, if desired, various curable monomers, oligomers and synthetic resins may be blended in the epoxy resin composition (a). Examples thereof include one or a combination of two or more of cyanate ester resins, acrylic resins, silicone resins and polyester resins. The blending ratio of these resins may fall within a range not detracting from the intrinsic properties of the epoxy resin composition (a), and is preferably 50 parts by mass or less relative to 100 parts by mass of the sum of the epoxy resin and the curing agent. On the other hand, the lower limit is not specifically limited but is preferably 1.0 part by mass or more.

Preferably, the epoxy resin sheet (A) in the present invention is formed of a cured product of the epoxy resin composition (a) containing an epoxy resin and an alicyclic polyamine.

### <Carrier Sheet (B)>

In the present invention, the carrier sheet (B) is preferably one that makes the tensile storage elastic modulus at 100° C. to 200° C. of the laminate be 6.0×10⁷ to 1.0×10¹⁰ Pa and makes the peel strength between the epoxy resin sheet (A) and the carrier sheet (B) be 5 N/15 mm or less.

Specifically, the peel strength between the epoxy resin sheet (A) and the carrier sheet (B) can be measured according to the method described in the section of Examples.

In the present invention, the peel strength between the epoxy resin sheet (A) and the carrier sheet (B) is 5 N/15 mm or less, preferably 3 N/15 mm or less, more preferably 1 N/15 mm or less. The lower limit is preferably 0.03 N/15 mm or more.

In the present invention, the thickness of the carrier sheet (B) is generally 20 μm to 500 μm, preferably 30 μm to 300 μm, more preferably 50 μm to 150 μm, even more preferably 55 μm to 120 μm. The thickness (average thickness) of the carrier sheet (B) can be measured with a micrometer and is an arithmetic average of the found data.

Here, in the case where the laminate of the present invention is a laminate having a carrier sheet (B) on both surfaces of the epoxy resin sheet (A), the thickness of the carrier sheet (B) means the thickness of each sheet.

In the present invention, as the carrier sheet (B), those that are appropriately selected so as to satisfy the above-mentioned characteristics can be used, and among thin sheets formed of a raw material of paper, plastics and metals, those that satisfy the tensile storage elastic modulus and the peel strength each falling within the above-mentioned range may be used. In particular, from the viewpoint of inexpensiveness, workability, disposability and recyclability, sheets of paper or plastics are used. As paper, any of high-quality paper, kraft paper, glassine paper, parchment paper, and those surface-coated with silicone such as super-calendered kraft paper can be used. Further, from the viewpoint of transparency, plastics are preferred. Usable plastics include polyethylene, polypropylene, polyethylene terephthalate, polycarbonate, polyethylene naphthalate and polyimide. These are surface-coated with a silicone resin release agent to control the peel strength. From the viewpoint of appearance, the carrier sheet (B) preferably includes a polyester film, and without overstepping the gist of the present invention, the resin film may have a single-layer configuration or a multilayer configuration of 2 or more layers. For example, from the viewpoint of peelability and suppression of transfer of the components constituting the release layer therein, the resin film for the carrier sheet (B) preferably has a 2-layered configuration of a polyester film and a polyolefin film. In the case where the sheet has a 2-layered configuration of a polyester film and a polyolefin film and where the polyolefin film side thereof is made to be in contact with the epoxy resin sheet (A), the peel strength between the epoxy resin sheet (A) and the carrier sheet (B) can be readily controlled to be 5 N/15 mm or less.

In the carrier sheet (B) of this case, the layer thickness ratio of the polyester film to the polyolefin film is preferably polyester film/polyolefin film=0.2 to 10, more preferably 0.3 to 5, even more preferably 0.5 to 3.

In this case, the polyester film exists to be the outermost surface of the laminate sheet, and the hardly adhesive polyolefin film exists to be in contact with the epoxy resin sheet (A). The surface of the polyolefin film may be coated with a release agent.

The polyester to constitute the polyester film is preferably one prepared by polycondensation of an aromatic dicarboxylic acid and an aliphatic glycol, and may be a polyester of one aromatic dicarboxylic acid and one aliphatic glycol, or may also be a copolyester further copolymerized with one or more other components. The aromatic dicarboxylic acid includes terephthalic acid, and 2,6-naphthalenedicarboxylic acid, and the aliphatic glycol includes ethylene glycol, diethylene glycol, and 1, 4-cyclohexanedimethanol. A polyethylene terephthalate is exemplified as a typical polyester. On the other hand, the dicarboxylic acid to be used as the component of the copolyester includes isophthalic acid, phthalic acid, terephthalic acid, 2,6-naphthalenedicarboxylic acid, and sebacic acid, and the glycol component includes ethylene glycol, diethylene glycol, propylene glycol, butanediol, 1,4-cyclohexanedimethanol, and neopentyl glycol. In addition, an oxycarboxylic acid such as p-oxybenzoic acid can also be used.

The polyester film may be an unstretched film or a stretched film, but is preferably a stretched film from the viewpoint of mechanical strength, and a biaxially stretched film is more preferred. The polyester film may be previously surface-treated by corona treatment or plasma treatment.

The polyolefin film may be any hitherto-known film such as a polyethylene film, a polypropylene film, or a poly 4-methyl-1-pentene or poly-1-butene film. From the viewpoint of releasability and low cost, a polyethylene film is more preferred, and low-density polyethylene is especially preferred.

The polyolefin film may be previously surface-treated by corona treatment or plasma treatment.

The carrier sheet (B) may also be so configured as to additionally have a release layer as the outermost layer on the side to be in contact with the epoxy resin sheet (A), in addition to the resin film. When the carrier sheet (B) further has a release layer in addition to the resin film, the peel strength between the epoxy resin sheet (A) and the carrier sheet (B) can be more readily controlled to be 5 N/15 mm or less.

The constituent component of the release layer is not specifically limited, and may contain a silicone compound, a fluorine compound, waxes and a surfactant and so on. From the viewpoint of good balance between cost and releasability, a silicone compound is preferably used.

Further, for controlling the peelability of the release layer, a peel controlling agent may be used additionally.

Available commercial products of the carrier sheet (B) that includes a polyester film and a release layer include “Purex A31” by Teijin Film Solutions Limited, and “MRF-38” by Mitsubishi Chemical Corporation.

A method for producing the epoxy resin sheet (A) or the laminate of the present invention includes peeling the carrier sheet (B) from the laminate of the present invention to give the epoxy resin sheet (A) or the laminate. Specifically, the laminate of the present invention is preferably one prepared by peeling the carrier sheet (B) from at least one surface of the laminate. In addition, the epoxy resin sheet (A) of the present invention is preferably one prepared by peeling the carrier sheet (B) from the laminate.

Of the epoxy resin sheet (A) or the laminate produced according to the production method, the appearance of the surface is not damaged, and therefore the sheet and the laminate can be favorably used even in the electrical and electronics field that requires a high level of precision. For example, they can be used for flexible or stretchable laminate plates that seriously require flexibility.

Examples of flexible or stretchable laminate plates include printed wiring boards laminated with a metal foil such as a copper foil. One example of a method for producing a printed wiring board. includes layering a copper foil on one or both surfaces of an epoxy resin sheet (A) and then hot-pressing it with a vacuum pressing machine to prepare a copper clad laminate plate, and then forming a wiring pattern by etching to give a printed wiring board. Also examplified is a printed wiring board that uses an electroconductive paste as the wiring pattern. Further, another example of the production method includes applying an electroconductive paste onto one or both surfaces of an epoxy resin sheet (A) by a known method of a screen printing method or an inkjet printing method to form a wiring pattern, thereby giving a printed wiring board. Preferably, the electroconductive paste has a flexible and stretchable.

By mounting various electronic elements on the printed wiring board, a flexible or stretchable device can be obtained.

Besides, the epoxy resin sheet (A) or the laminate can also be used for buffer materials, sticky sheets, elastic tapes and also substrates for various sensors such as pressure sensors, as electronics and electrical parts.

A sticky sheet can be used as a filler to fill up a space between an image display panel such as a liquid-crystal display (LCD), a plasma display panel (PDP) and an electroluminescent display (ELD), and a protective panel, a touch panel, etc. to be arranged on the front side (viewing side) in a use situation.

In addition, including the use in other fields than the field of electronic and electrical parts, the sheet and the laminate can also be applicable to various industrial buffers, sticky sheets, adhesive sheets, elastic tapes, sealing sheets, heat-resistant insulating sheets, heat-resistant conductive sheets, glass substitutes, protective films, medical sheets, agricultural sheets and construction sheets.

### [Wound Body]

The wound body of the present invention is one obtained by winding a laminate that has an epoxy resin sheet (A) and a carrier sheet (B) on at least one surface of the epoxy resin sheet (A), around a core, wherein the epoxy resin sheet (A) has a tensile storage elastic modulus at 100° C. to 200° C. of 1.0×10⁴ to 6.0×10⁷ Pa and a tensile elongation of 150% or more, the tensile storage elastic modulus at 100° C. to 200° C. of the laminate is 6.0×10⁷ to 1.0×10¹⁰ Pa, and the peel strength between the epoxy resin sheet (A) and the carrier sheet (B) is 5 N/15 mm or less. Preferred embodiment of the wound body includes the same as those of the laminate of the present invention mentioned above.

As described above, the tensile storage elastic modulus at 100° C. to 200° C. of a general epoxy resin sheet is 0.1 GPa to 10 GPa or so, and the tensile elongation thereof is 10% or so, but the epoxy resin sheet having such properties is too hard, and naturally, therefore, when the epoxy resin sheet of this type is wound up to be a wound body, there may occur various defects of wrinkling and cracking. As described above, the wound body of the present invention is soft. Using he epoxy resin sheet (A), the laminate can be readily formed into a wound body.

In addition, for the wound body of the present invention, the laminate has a specific tensile storage elastic modulus and a specific tensile elongation, and therefore, in unwinding the wound body in use, the handleability of the wound body is good (that is, the wound body is free from defects of elongation, deflection, wrinkling).

In the wound body of the present invention, the length of the laminate is preferably 10 m or more, more preferably 20 m or more. When the length of the laminate is 10 m or more, for example, in the case where the wound body is used as a flexible or stretchable laminate plate, electronic parts can be produced continuously, and the wound body is excellent in continuous film-forming property. The upper limit of the length is not specifically limited but is preferably 1000 m or less.

In the wound body of the present invention, the thickness fluctuation of the laminate is preferably 20% or less, more preferably 15% or less, even more preferably 10% or less, further even more preferably 5.0% or less. When the thickness fluctuation of the laminate is 20% or less, a wound body can be realized such that the thickness of the laminate is made uniform and the thickness fluctuation thereof is retarded. Accordingly, the wound body can be produced with good productivity for flexible or stretchable laminate plates. The thickness fluctuation of the laminate is preferably smaller, and the lower limit thereof is 0% or more.

### <Core>

The core is a columnar winding core to be used for winding a laminate. Examples of the material for the core include paper, resin-infiltrated paper, acrylonitrile/butadiene/styrene copolymer (ABS resin), fiber-reinforced plastics (FRP), phenolic resins, and inorganic material-containing resins. An adhesive may be used for the core.

Though not specifically limited but from the viewpoint of having a small thermal expansion coefficient, being highly rigid, poorly swellable relative to humidity, and excellent in winding property, the core material is preferably plastics or thermosetting resins.

In the case where the core material is paper, the core can readily attain desired properties especially when the surface thereof is coated with a resin or the like.

From the viewpoint of surface smoothness, the core is preferably a resin-infiltrated paper tube.

The outer diameter of the core is preferably 10 mm or more and 2,000 mm or less, more preferably 15 mm or more and 1,900 mm or less, even more preferably 20 mm or more and 1,700 mm or less. The core having an outer diameter of 10 mm or more is especially useful in this embodiment since the laminate is readily influenced by the quality of the core.

### EXAMPLES

Hereinunder the present invention is described more specifically based on Examples, but the present invention is not whatsoever restricted by the following Examples. The values of various production conditions and evaluation results in the following Examples have a meaning as a preferred upper limit value or lower limit value, and the preferred range may fall within a range as defined by a combination of the above-mentioned upper limit or lower limit value and the value in the following Examples or a combination of the values in different Examples. In the following, “part” is all “part by mass”.

### [Various Analysis, Evaluation and Measurement Methods]

Analysis, evaluation and measurement methods for various physical properties and characteristics mentioned below are as follows.

### (1) Tensile Storage Elastic Modulus

According to a dynamic viscoelasticity measurement method of JIS K7244 using a dynamic viscoelasticity measuring device (“DVA-200” by IT Instrumentation Control Co., Ltd.), a sample was tested at a frequency of 1 Hz and a heating rate of 3° C./min and under a double-sided tensile mode measurement condition to measure the storage elastic modulus E′ thereof at 100° C., 150° C. and 200° C.

### (2) Tensile Elongation

According to JIS K7161 in an environment at 23° C. and 50%, a sample for evaluation was tested in a tensile test at a test speed of 200 mm/min to measure the elongation at break thereof.

### (3) Peel Strength

A laminate was cut into a test piece having a length of 250 mm and a width of 15 mm, and using a universal testing machine (“AGS-X” by Shimadzu Corporation), the test piece was tested in a T-type peel test at the interface between the epoxy resin sheet (A) layer and the carrier sheet (B) layer at a test speed of 50 mm/min to measure the peel force between displacements of 30 mm and 60 mm, and the found data were averaged to give an average value as the peel strength of the tested sample.

### (4) Deflection Resistance <Fixed End Self Weight Deflection Measurement>

A laminate was cut into a strip-like test piece of 25 mm×300 mm. Both sides of the test piece in a length of 50 mm each were put on horizontal desk sides, and a load was given to the test piece. The part of 150 mm between marked lines was kept suspended, the sample was left in an environment at 24° C. for 5 minutes, and the distance between the naturally deflected end in the center part and the horizontal face was measured. The distance between the center part of the test piece and the fixed horizontal face thereof is referred to as a deflection variate, and the deflection resistance of the sample was evaluated as follows.

A small value of the deflection variate means that, for example, when the laminate is die-cut in secondary working, the deflection (warping) of the die-cut laminate is suppressed.

A: An absolute value of the deflection variate is 0 mm or more and 5.0 mm or less.

B: An absolute value of the deflection variate is more than 5.0 mm and 7.0 mm or less.

C: An absolute value of the deflection variate is more than 7.0 mm.

### (5) Elongation Resistance

A laminate was cut into a strip-like test piece of 12.5 mm×200 mm to be a sample.

Using a tensile tester, the sample was tested in a tensile test in which the distance between the marked lines was 100 mm and the test speed was 200 mm/min. The elongation of each sample at a load of 50 N was measured. The sample was evaluated based on the following standards.

A small value of the elongation means that, for example, when the laminate is die-cut in secondary working, the dimensional stability of the die-cut laminate is good.

A: The elongation is 0% or more and 2.0% or less.

B: The elongation is more than 2.0% and 20% or less.

C: The elongation is more than 20%.

### (6) Evaluation of Appearance of Epoxy Resin Sheet (A)

A laminate sample of a 10 cm square was cut out. The ease of peeling by hand in peeling the carrier sheet (B) on one side from the laminate, and the surface condition of the epoxy resin sheet (A) after the carrier sheet was peeled were evaluated based on the following standards.

A: The carrier sheet peeled extremely easily with no resistance to peeling. On the entire surface of the epoxy resins sheet in a size of 10 cm square, any other change than glossiness could not be confirmed visually, as compared with the condition of the laminate still having the carrier sheet at least on one surface thereof. A smooth surface of the carrier sheet was sufficiently transferred to the surface of the epoxy resin sheet, and the surface of the epoxy resin sheet is smooth.

B: The carrier sheet peeled easily with no resistance to peeling. On the entire surface of the epoxy resins sheet in a size of 10 cm square, any flaw could not be confirmed visually.

C: The carrier sheet peeled with some resistance to peeling. On the surface of the epoxy resins sheet in a size of 10 cm square, “saw-tooth” like lines were confirmed visually.

D: Resistance to peeling was great. On the surface of the epoxy resins sheet in a size of 10 cm square, whiteness and roughness were confirmed visually.

(7) Thickness of Laminate, and Thickness Fluctuation of Laminate in Wound body

The thickness of a laminate was measured at intervals of 100 mm in the width direction from the edge of the laminate, and the found data were averaged to give an average value for the thickness of the laminate.

The thickness fluctuation of the laminate in a wound body was evaluated from the maximum value as calculated according to the following numerical expression. The wound body was heat-treated before the test, and the thickness of the laminate in the wound body was measured in 5 sites at intervals of 2 m from the roll outermost layer, and at intervals of 100 mm in the width direction from the edge of the laminate, and the found data were averaged to give an average value for the thickness.

Thickness fluctuation of laminate [%]=100×|(maximum value or minimum value of thickness of laminate)−(thickness of laminate)|/(thickness of laminate)

A: The thickness fluctuation of laminate is 0% or more and 10% or less.

B: The thickness fluctuation of laminate is more than 10% and 20% or less.

C: The thickness fluctuation of laminate is more than 20%.

### (8) Continuous Film-Forming Property

In producing a wound body, the continuous film-forming property was evaluated based on the length of the continuously wound laminate, as follows. In winding, at the time when the laminate greatly wrinkled, the laminate was considered to be no more windable.

A: The length of the windable laminate is 20 m or more.

B: The length of the windable laminate is 10 m or more but less than 20 m.

C: The length of the windable laminate is less than 10 m.

In Examples and Comparative Examples, the epoxy resin sheet (A), the laminate and the wound body were produced as follows.

### <Materials Used for Epoxy Resin Sheet (A)>

### (Epoxy Resin (α))

Previously heated at 45° C., 141.8 parts by mass of 1,6-hexanediol and 0.51 parts by mass of boron trifluoride ethyl ether were put into a 1-Liter glass flask equipped with a stirrer, a dropping funnel and a thermometer, and heated up to 80° C. 244.3 parts by mass of epichlorohydrin was dropwise added thereto, taking time such that the temperature does not become 85° C. or more. After ripened for 1 hour while kept at 80 to 85° C., this was cooled down to 45° C. 528.0 parts by mass of an aqueous 22 mass % sodium hydroxide solution was added thereto, and vigorously stirred at 45° C. for 4 hours. Cooled down to room temperature to separate and remove the aqueous phase, this was again heated under reduced pressure to remove unreacted epichlorohydrin and water thereby giving 283.6 parts by mass of crude 1,6-hexanediol diglycidyl ether.

The crude 1,6-hexanediol diglycidyl ether was purified through distillation with an Oldershaw distillation column (15 stages) to isolate a fraction under a pressure of 1300 Pa and at 170 to 190° C. as a main fraction, thereby giving 127.6 parts by mass of 1,6-hexanediol diglycidyl ether having a diglycidyl purity of 97% by mass, a total chlorine content of 0.15% by mass and an epoxy equivalent of 116 g/eq by gas chromatography.

100 parts by mass of this 1,6-hexanediol diglycidyl ether, 69.3 parts by mass of bisphenol F (phenolic hydroxyl equivalent: 100 g/eq), and 0.13 parts by mass of ethyltriphenylphosphonium iodide (30 mass % methyl cellosolve solution) were put into a pressure-resistant container, and polymerized in a nitrogen gas atmosphere at 165 to 170° C. for 5 hours to give a copolymer of bisphenol F and 1,6-hexanediol diglycidyl ether having an epoxy equivalent of 1,000 g/eq and a number-average molecular weight of 3,000.

### (Curing Agent)

Alicyclic polyamine (“jER Cure ST-14” by Mitsubishi Chemical Corporation).

### <Carrier Sheet (B)>

Carrier sheet (1): OPP/PET film (a two-type tow-layer film prepared by sticking an unmodified polypropylene (oriented polypropylene: OPP) film having a thickness of 50 μm and a biaxially-stretched polyethylene terephthalate (PET) film having a thickness of 50 μm).

Carrier sheet (2): LDPE/PET film (a two-type tow-layer film prepared by sticking a low-density polyethylene (LDPE) film having a thickness of 50 μm and a biaxially-stretched polyethylene terephthalate (PET) film having a thickness of 50 μm).

Carrier sheet (3): Purex A31 by Teijin Film Solutions Limited, a one-side silicone-coated PET film having a thickness of 100 μm.

Carrier sheet (4): Stretchlon 800 (by Airtech Japan, Ltd., a nylon-based film having a thickness of 50 μm).

Carrier sheet (5): Diafoil T100 (by Mitsubishi Chemical Corporation, an uncoated PET film having a thickness of 100 μm).

Carrier sheet (6): Diafoil MRF-75 (by Mitsubishi Chemical Corporation, a one-side silicone-coated PET film having a thickness of 75 μm).

### Examples 1 to 2, Comparative Examples 1 to 2

The curing agent was blended to the epoxy resin (α) in a ratio shown in Table 1 to give a flexible epoxy resin composition. The epoxy resin composition was sandwiched between two carrier sheets (B) shown in Table 1 and controlled to have a desired thickness. This was heat-treated at 40° C. for 16 hours, and further heat-treated at 80° C. for 6 hours to give a stretchable epoxy sheet laminate of Examples 1 to 2 and Comparative Examples 1 to 2. Evaluation of the laminates is shown in Table 1.

As in Examples 1 and 2 where the carrier sheet (B) is two-layered, the PET layer is the outermost surface of the laminate and the olefin-based layer is kept in contact with the flexible epoxy sheet.

### Example 3

A laminate of a stretchable epoxy sheet was produced in the same manner as in Example 1 except that the curing condition was changed to heat treatment at 40° C. for 16 hours followed by further heat treatment at 80° C. for 3 hours. Evaluation of the laminate is shown in Table 1. The epoxy sheet is in a semi-cured state.

### Example 4

The curing agent was blended to the epoxy resin (α) in a ratio shown in Table 1 to give a flexible epoxy resin composition. The epoxy resin composition was applied to one surface (olefin-based layer) of the carrier sheet (B) shown in Table 1 and controlled to have a desired thickness. This was heat-treated at 40° C. for 16 hours, and further heat-treated at 80° C. for 6 hours to give a stretchable epoxy sheet laminate of Example 4. Evaluation of the laminates is shown in Table 1.

TABLE 1

| | | | | Example | | | | Comparative Example | |
|---|---|---|---|---|---|---|---|---|---|
| | | | | 1 | 2 | 3 | 4 | 1 | 2 |
| Epoxy Resin Sheet | Raw | Epoxy Resin (α) | part by | 100 | 100 | 100 | 100 | 100 | 100 |
| (A) | Materials | | mass | | | | | | |
| | | Alicyclic Polyamine | part by | 8.5 | 8.5 | 8.5 | 8.5 | 8.5 | 8.5 |
| | | | mass | | | | | | |
| | Average Thickness | | μm | 120 | 120 | 120 | 120 | 120 | 100 |
| Carrier Sheet | Kind of | Carrier Sheet (1) | | 0 | | | | | |
| (B) | Sheet | Carrier Sheet (2) | | | 0 | | 0 | | |
| | | Carrier Sheet (3) | | | | 0 | | | |
| | | Carrier Sheet (4) | | | | | | 0 | |
| | | Carrier Sheet (5) | | | | | | | 0 |
| | Average Thickness | | μm | 100 | 100 | 100 | 100 | 50 | 100 |
| Layer Configuration | | | | B-A-B | B-A-B | B-A-B | B-A | B-A-B | B-A-B |
| Tensile Elongation | (A) alone | | % | 354 | 354 | 365 | 350 | 282 | unmeasurable |
| Tensile Storage | (A) alone | 100° C. | Pa | 2.4 × 10⁶ | 2.4 × 10⁶ | 1.6 × 10⁶ | 2.4 × 10⁶ | 2.4 × 10⁶ | unmeasurable |
| Elastic Modulus E′ | | 150° C. | Pa | 2.6 × 10⁶ | 2.6 × 10⁶ | 1.8 × 10⁶ | 2.6 × 10⁶ | 2.6 × 10⁶ | unmeasurable |
| (dynamic | | 200° C. | Pa | 2.4 × 10⁶ | 2.4 × 10⁶ | 1.9 × 10⁶ | 2.4 × 10⁶ | 2.5 × 10⁶ | unmeasurable |
| viscoelasticity) | Laminate | 100° C. | Pa | 7.9 × 10⁸ | 8.3 × 10⁸ | 1.4 × 10⁹ | 5.1 × 10⁸ | 1.4 × 10⁸ | 1.4 × 10⁹ |
| | | 150° C. | Pa | 1.9 × 10⁸ | 2.2 × 10⁸ | 4.3 × 10⁸ | 1.5 × 10⁸ | 1.1 × 10⁸ | 4.4 × 10⁸ |
| | | 200° C. | Pa | 9.7 × 10⁷ | 1.1 × 10⁸ | 1.7 × 10⁸ | 7.2 × 10⁷ | 5.4 × 10⁷ | 1.9 × 10⁸ |

| Peel Strength | — | N/15 mm | 2.2 | 0.1 | 0.05 | 0.1 | 7.9 | 12.1 |
|---|---|---|---|---|---|---|---|---|
| Fixed End Self | — | mm | 2.8 | 4.2 | 2.3 | 5.8 | 7.8 | 2.2 |
| Weight Deflection | | | | | | | | |
| Measurement | | | | | | | | |
| Deflection Resistance | | | A | A | A | B | C | A |
| Tensile Test | — | % | 0.82 | 1.06 | 0.56 | 2.05 | 27.9 | 0.65 |

| | | | | | | |
|---|---|---|---|---|---|---|
| Elongation Resistance | A | A | A | B | C | A |
| Evaluation of Appearance of Epoxy Resin Sheet (A) | B | A | A | A | C | D |

### Examples 5 and 6

Stretchable epoxy sheet laminates were produced in the same manner as in Example 1 except that the thickness of the epoxy resin sheet (A) was changed to 80 μm and 200 μm, respectively. Evaluation of the laminates is shown in Table 2.

### Example 7

A stretchable epoxy sheet laminate was produced in the same manner as in Example 1 except that the carrier sheet (B) was changed as in Table 2. Evaluation of the laminate is shown in Table 2.

TABLE 2

| | | | | Example | | |
|---|---|---|---|---|---|---|
| | | | | 5 | 6 | 7 |
| Epoxy Resin Sheet | Raw | Epoxy Resin (α) | part by | 100 | 100 | 100 |
| (A) | Materials | | mass | | | |
| | | Alicyclic Polyamine | part by | 8.5 | 8.5 | 8.5 |
| | | | mass | | | |
| | Average Thickness | | μm | 80 | 200 | 120 |
| Carrier Sheet | Kind of | Carrier Sheet (1) | | 0 | 0 | |
| (B) | Sheet | Carrier Sheet (6) | | | | 0 |
| | Average Thickness | | μm | 100 | 100 | 75 |
| Layer Configuration | | | | B-A-B | B-A-B | B-A-B |
| Tensile Elongation | (A) alone | | % | 354 | 354 | 365 |
| Tensile Storage Elastic | (A) alone | 100° C. | Pa | 2.4 × 10⁶ | 2.4 × 10⁶ | 1.6 × 10⁶ |
| Modulus E′ | | 150° C. | Pa | 2.6 × 10⁶ | 2.6 × 10⁶ | 1.8 × 10⁶ |
| (dynamic viscoelasticity) | | 200° C. | Pa | 2.4 × 10⁶ | 2.4 × 10⁶ | 1.9 × 10⁶ |
| | Laminate | 100° C. | Pa | 7.8 × 10⁸ | 4.4 × 10⁸ | 1.4 × 10⁹ |
| | | 150° C. | Pa | 1.7 × 108 | 1.1 × 10⁸ | 2.8 × 10⁸ |
| | | 200° C. | Pa | 8.2 × 10⁷ | 6.0 × 10⁷ | 1.1 × 10⁸ |

| Peel Strength | — | N/15 mm | 2.2 | 0.1 | 0.05 |
|---|---|---|---|---|---|
| Fixed End Self Weight | — | mm | 2.4 | 3.9 | 2.1 |
| Deflection Measurement | | | | | |
| Deflection Resistance | | | A | A | A |
| Tensile Test | — | % | 0.81 | 1.2 | 1.2 |

| | | | |
|---|---|---|---|
| Elongation Resistance | A | A | A |
| Evaluation of Appearance of Epoxy Resin Sheet (A) | B | A | A |

### Example 8

The laminate of Example 1 prepared by sandwiching the epoxy resin composition between two carrier sheets (B) shown in Table 1 was wound around a paper core (outer diameter: 12.7 cm) by 50 m, and then heat-treated in the same manner as in Example 1 to give a wound body. Evaluation of the wound body is shown in Table 3.

### Examples 9 and 10

Wound bodies were produced in the same manner as in Example 8 except that the laminates produced in Examples 5 and 6 were used, respectively. Evaluation of the wound bodies is shown in Table 3.

TABLE 3

| | | Example | | |
|---|---|---|---|---|
| | | 8 | 9 | 10 |
| Thickness Fluctuation | — | A | A | A |
| Continuous Film-Forming Property | — | A | A | A |

It was confirmed that the stretchable epoxy sheet laminates obtained in Examples 1 to 4 were excellent in elongation resistance and deflection resistance and therefore secure good handleability in secondary working (namely, suppressed in defects of wrinkling, elongation and deflection). Further, when the carrier layer is peeled, the surface appearance of the epoxy resin sheet is not worsened, and therefore the epoxy resin sheet can be put to practical use. In addition, the laminate of the present invention can be formed into a film continuously, and therefore a wound body thereof can be produced easily.

1. A laminate comprising an epoxy resin sheet (A) and carrier sheet (B) on at least one surface of the epoxy resin sheet (A), wherein:
the epoxy resin sheet (A) has a tensile storage elastic modulus at 100° C. to 200° C. of 1.0×10⁴ to 6.0×10⁷ Pa and a tensile elongation of 150% or more,
the tensile storage elastic modulus at 100° C. to 200° C. of the laminate is 6.0×10⁷ to 1.0×10¹⁰ Pa, and
the peel strength between the epoxy resin sheet (A) and the carrier sheet (B) is 5 N/15 mm or less.

2. The laminate according to claim 1, comprising the carrier sheet (B) on both surfaces of the epoxy resin sheet (A).

3. The laminate according to claim 1, wherein the carrier sheet (B) comprises a polyester film.

4. The laminate according to claim 1, wherein the carrier sheet (B) comprises a release layer.

5. The laminate according to claim 1, wherein the carrier sheet (B) has a two-layered configuration of a polyester film and a polyolefin film

6. The laminate according to claim 5, wherein, in the carrier sheet (B), the layer thickness ratio of the polyester film to the polyolefin film is polyester film/polyolefin film=0.2 to 10.

7. The laminate according to claim 1, wherein the epoxy resin sheet (A) is formed of a cured product obtained by curing an epoxy resin composition containing an epoxy resin and an alicyclic polyamine.

8. The laminate according to claim 7, wherein the epoxy resin has a block structure of a rigid component and a soft component.

9. The laminate according to claim 1, having a thickness of 30 μm to 1000 μm.

10. A laminate obtained by peeling the carrier sheet (B) from one surface of the laminate of claim 2.

11. A flexible or stretchable laminate plate using the epoxy resin sheet (A) of the laminate of claim 1.

12. A method for producing an epoxy resin sheet, comprising peeling the carrier sheet (B) from the laminate of claim 1 to give the epoxy resin sheet (A).

13. A wound body obtained by winding a laminate that has an epoxy resin sheet (A) and a carrier sheet (B) on at least one surface of the epoxy resin sheet (A), around a core, wherein:
the epoxy resin sheet (A) has a tensile storage elastic modulus at 100° C. to 200° C. of 1.0×10⁴ to 6.0×10⁷ Pa, and a tensile elongation of 150% or more,
the tensile storage elastic modulus at 100° C. to 200° C. of the laminate is 6.0×10⁷ to 1.0×10¹⁰ Pa, and
the peel strength between the epoxy resin sheet (A) and the carrier sheet (B) is 5 N/15 mm or less.
